(19) United States
(12) Patent Application Publication
(10) Pub. No.: US 2013/0123372 A1
(43) Pub. Date: May 16, 2013

(54) EMULSIONS CONTAINING POLYMERIC CATIONIC EMULSIFIERS, SUBSTANCE AND PROCESS

(71) Applicant: BASF SE, Ludwigshafen (DE)

(72) Inventors: Rainer Dobrawa, Stuttgart (DE); Dieter Boeckh, Limburgerhof (DE); Aaron Flores-Figuerroa, Ludwigshafen (DE); Markus Brym, Limburgerhof (DE); Rajan K. Panandiker, West Chester, OH (US); Frank Huelskoetter, Bad Durkheim (DE)

(73) Assignee: BASF SE, Ludwigshafen (DE)

(21) Appl. No.: 13/673,154

(22) Filed: Nov. 9, 2012

Related U.S. Application Data
(60) Provisional application No. 61/558,473, filed on Nov. 11, 2011.

(51) Int. Cl. C08L 47/00; C08F 236/20

(52) U.S. Cl. CPC C08L 47/00; C08F 236/20
USPC 514/772.6; 524/555; 524/320; 526/295

(57) ABSTRACT

The present invention is directed to stable emulsions comprising oils and a polymeric cationic emulsifier, the process to obtain said emulsions and the use of said emulsions.

The present invention is directed to stable emulsions comprising oils and a polymeric cationic emulsifier, the process to obtain said emulsions and the use of said emulsions.

Oils such as silicone oils, natural oils, polyolefines and in particular polyisobutene are useful ingredients in a lot of technical applications. It is, however, still difficult to obtain stable emulsions comprising such oil(s) and water. There is always a need to add either surfactants or huge amounts of additional polymer.

PCT/EP2011/057586, which has not yet been published, discloses an emulsion comprising (a) polyolefines such as polyisobutene, polymers Px which are copolymers of non ionic, anionic or pseudocationic monomers and water.

DE 195 05 100 A1 relates to the preparation of polymers which are the product of the polymerization of bisesters of akyl-or alkenyl carboxylic acid derivatives and polyalcohols. These polymers are used as solubilisers, emulsifiers and cleaning compounds.

WO 2007/042454 A1 describes the use of terpolymers of (a) maleic anhydride, (b) isobutylene and (c) polyisobutylene for producing aqueous emulsions or dispersions of hydrophobic substances such as silicones.

WO 2007/014915 writes on aqueous dispersions comprising (A) a polymer such as polyisobutene and (B) an emulsifier obtained by the polymerization of isobutylene, maleic anhydride and polyethyleneglycol. This dispersion is used for the treatment of leather or as additive in construction chemicals.

EP 0 995 791 A1 discloses a polymer formed by copolymerizing two or more monomers A, B and C, wherein A is selected from one or more C3-C8 monoethylenically unsaturated carboxylic acid moieties, B can be a C3-C60 alkyl(meth)acrylate and C is an ethylenically unsaturated monomer which is copolymerizable with monomers A and B. According to the disclosure, the polymer is used in solid form or liquid form, as an aqueous or co-solvent based solution, to promote the release of oily soil from fabrics.

U.S. Pat. No. 2,923,701 writes on a composition comprising a linear copolymer which is the product of (1) a single quaternary ammonium compound such as dially dimethyl ammonium chloride and (2) an ethylenically unsaturated compound. This copolymer may yield a fiber-forming copolymer or can be used as textile treating agent.

Therefore it is one goal of the present invention to provide an emulsion containing oil(s) and water, which display a good stability and which are suitable for the use in chemical technical applications, car wash, cosmetics, plant protection, preparation and treatment of paper, textiles and leather, adhesives, dye and pigment formulations, coatings, pharmaceutical applications, construction, wood treatment.

This goal is surprisingly reached by the emulsions according to claims 1 to 11. The process of producing a stable emulsion, the use of such an emulsion according to claims 12 and 13 respectively as well as the polymeric cationic emulsifier according to claims 14 and 15 form additional aspects of the present invention.

For the purpose of this invention the prefix (meth) written before a compound means the respective unsubstituted compound and/or the compound substituted by the methyl group. For instance, “(meth)acrylic acid” means acrylic acid and/or methacrylic acid, (meth)acrylate means acrylate and/or methacrylate, (meth)acrylamide means acrylamide and/or methacrylamide.

Thus the present invention is directed to an emulsion comprising
a) oil(s) in an amount of from 2 to 75 weight %,
b) polymeric cationic emulsifiers Px in an amount of from 0.05 to 40 weight %,
wherein Px is the product of the polymerization of
A) one or more cationic ethylenically unsaturated monomers (monomer A),
B) one or more linear or branched alkyl(meth)acrylates (monomer B),
C) from 0 to 30 weight % of one or more C3-C8 monoethylenically unsaturated carboxylic acids (monomer C),
c) surfactant(s) Sx in an amount of from 0 to 25 weight %,
d) additive(s) Ax in an amount of from 0 to 20 weight % and
e) water in an amount of from 10 to 97.95 weight %,
based on the total weight of the emulsion.

The emulsion can consist of components a), b) and e), in which case the amounts add up to 100 weight %,—such an emulsion forms a preferred embodiment of the present invention. The emulsion can also contain components a), b) and e) as well as additional components. Emulsions, which in addition to components a), b) and e) also contain components c) and/or d) form one preferred embodiment of the invention. The inventive emulsion may also contain other components.

With regard to the amounts, in which the respective compounds are present in the emulsion, there exist preferred ranges. Thus an emulsion according to the invention, wherein the components independently of each other are present in amounts of:
a) oil(s) in an amount of from 5 to 50 weight %,
b) polymeric cationic emulsifiers Px in an amount of from 0.5 to 30 weight %,
wherein Px is the product of the polymerization of
A) one or more monomers A,
B) one or more monomers B,
C) from 0 to 30 weight % of one or more monomers C,
c) surfactant(s) Sx in an amount of from 0.1 to 20 weight %,
d) additive(s) Ax in an amount of from 0.1 to 15 weight % and
e) water in an amount of from 30 to 90 weight %,
based on the total weight of the emulsion, forms a preferred embodiment of the present invention.

Even more preferred is an emulsion, wherein the components independently of each other are present in amounts of:
a) oil(s) in an amount of from 10 to 40 weight %,
b) polymeric cationic emulsifiers Px in an amount of from 0.5 to 15 weight %,
wherein Px is the product of the polymerization of
A) one or more monomers A,
B) one or more monomers B,
C) from 0 to 30 weight % of one or more monomers C,
c) surfactant(s) Sx in an amount of from 0,1 to 15 weight %,
d) additive(s) Ax in an amount of from 1 to 10 weight % and
e) water in an amount of from 40 to 85 weight %,
based on the total weight of the emulsion.

And most preferred is an emulsion, wherein the components of the emulsion independently of each other are present in amounts of:
a) oil(s) in an amount of from 15 to 30 weight %,
b) polymeric cationic emulsifiers Px in an amount of from 0.5 to 5 weight %,
wherein Px is the product of the polymerization of
A) one or more monomers A,
B) one or more monomers B,
C) from 0 to 30 mass % of one or more monomers C,
c) surfactant(s) Sx in an amount of from 0.5 to 10 weight %,
d) additive(s) Ax in an amount of from 2 to 8 weight % ad
e) water in an amount of from 50 to 80 weight %,
based on the total weight of the emulsion.

To maximize the content of oil(s), it is advantageous to reduce the amount of other components in the emulsion. Therefore, further preferred emulsions are those, which comprise:
a) oil(s) in an amount of from 15 to 35 weight %,
b) polymeric cationic emulsifiers Px in an amount of from 0.5 to 10 weight %,
c) surfactant(s) Sx in an amount of from 4 to 12 weight %,
d) additive(s) Ax in an amount of from 0 to 10 weight % and
e) water in an amount of from 33 to 80.5 weight %,
based on the total weight of the emulsion,
a) oil(s) in an amount of from 15 to 35 weight %,
b) polymeric cationic emulsifiers Px in an amount of from 0.5 to 10 weight %,
c) surfactant(s) Sx in an amount of from 4 to 12 weight %,
d) additive(s) Ax in an amount of 0 weight % and
e) water in an amount of from 33 to 80.5 weight %,
based on the total weight of the emulsion,
a) oil(s) in an amount of from 15 to 35 weight %,
b) polymeric cationic emulsifiers Px in an amount of from 0.5 to 10 weight %,
c) surfactant(s) Sx in an amount of from 4 to 12 weight %,
d) additive(s) Ax in an amount of 0 weight % and
e) water in an amount of from 33 to 80.5 weight %,
based on the total weight of the emulsion,
a) oil(s) in an amount of from 15 to 30 weight %,
b) polymeric cationic emulsifiers Px in an amount of from 0.5 to 30 weight %,
c) surfactant(s) Sx in an amount of 0 weight %,
d) additive(s) Ax in an amount of from 2 to 8 weight % and
e) water in an amount of from 50 to 80 weight %,
based on the total weight of the emulsion
or
a) oil(s) in an amount of from 15 to 30 weight %,
b) polymeric cationic emulsifiers Px in an amount of from 0.5 to 5 weight %,
c) surfactant(s) Sx in an amount of 0 weight %,
d) additive(s) Ax in an amount of 0 weight % and
e) water in an amount of from 50 to 80 weight %,
based on the total weight of the emulsion.

Not only the amount but also the nature of the components of the inventive emulsion can be chosen advantageously.

The oil(s) used in the present invention is/are selected from the group consisting of:
a1) polyolefines,
a2) silicone oils,
a3) natural oil(s),
a4) mineral oils, having a boiling point at atmospheric pressure of 150° C. or higher,
a5) esters of C10- to C26-carboxylic acid with C8-C24-alcohols, and/or mixtures thereof.

Oils according to the invention refer to hydrophobic substances, which are liquid at ambient temperature.

In general polyolefine(s) as used in the present invention is/are a chemical compound(s) consisting of carbon and hydrogen atoms. The polyolefine(s) can be linear, e.g. polyethylene, or can have side chains, e.g. polypropylene having methyl-side chains, which side chains may be that long that comb-like structures are found, or can be co- or ter-polymers, e.g. ethene/propene-copolymer or ethane/propene/hexane-terpolymer. It is particularly preferred, when the polyolefine(s) is/are substantially homopolymers, i.e. the degree of co- or ter-monomer is below 10 mass %, preferably below 5 mass % based on the mass of the polymer. It is particularly preferred, if the polymer(s) is/are homopolymers, i.e. they consist of only one kind of monomer.

In particular an emulsion, wherein the polyolefine(s) a1) is/are selected from the group consisting of: polyethylene, polypropylene, polybutylene and polyisobutylene is preferred. The emulsion can comprise one or more polyolefine(s). An emulsion, which only comprises one polyolefine a1) is preferred. An emulsion, which only comprises polyisobutylene as polyolefine a1) is particularly preferred. The polyolefines a1) can be prepared by the usual procedures (Ullmann's Encyclopedia of Industrial Chemistry, Polyolefins, Whiteley, Heggs, Koch, Mawer, Immel, Wiley-VCH Verlag GmbH & Co. KGaA, Weinheim 2005). The production of polyisobutylene is described e.g. in WO 02/06359 and WO 96/40808 in even more detail. The polyolefine(s) al) preferably has/have of molar mass (Mn) of at least 250 g/mol, preferably at least 350 g/mol and more preferred at least 500 g/mol. The polyolefine(s) a1) have a maximum molar mass Mn of 10.000 g/mol, preferably 5000 g/mol and more preferred of 2500 g/mol. The most preferred range of the molar mass Mn of polyolefins al) is from 550 to 2000 g/mol.

Suitable silicone oils a2) contained within the emulsion of the present invention are, for example, linear polydimethylsiloxanes,

poly(methylphenylsiloxanes), cyclic siloxanes and mixtures thereof. The number-average molecular weight of the polydimethylsiloxanes and

poly(methylphenylsiloxanes) is preferably in a range from about 1000 to 150 000 g/mol. Preferred cyclic siloxanes have 4- to 8-membered rings. Suitable cyclic siloxanes are commercially available, for example, under the name cyclomethicone.

Preferred natural oils a3) contained within the emulsion of the present invention are, for example, castor oil, soya oil, peanut oil, olive oil, sunflower oil, sesame oil, avocado oil, cocoa butter, almond oil, peach kernel oil, ricinus oil, cod-liver oil, pig fat, spermaceti, spermaceti oil, sperm oil, wheatgerm oil, macadamia nut oil, evening primrose oil, jojoba oil; fatty alcohols, such as lauryl alcohol, myristyl alcohol, cetyl alcohol, stearyl alcohol, oleyl alcohol, cetyl alcohol; fatty acids, such as myristic acid, stearic acid, palmitic acid, oleic acid, linoleic acid, linolenic acid and saturated, unsaturated and substituted fatty acids different therefrom; and mixtures of the abovementioned oil and fat components.

Preferred mineral oils a4) contained within the emulsion of the present invention available under the names mineral oil light, mineral oil heavy, paraffin liquid or Nujol, that are liquid at room temperature.

Also the emulsion according to the invention comprises polymer(s) PX, wherein Px is the product of the polymerization of
A) one or more cationic ethylenically unsaturated monomers (monomer A),
B) one or more linear or branched alkyl(meth)acrylates (monomer B),
C) from 0 to 30 weight % of one or more C3-C8 monoethylenically unsaturated carboxylic acids (monomer C).

Monomer A is a cationic monoethylenically unsaturated monomer which is at least partially soluble in water of the reaction solvent. Suitable examples of monomer A are (3-acrylamidopropyl)-trimethylammonium chloride (APTAC), diallyl dimethyl ammonium chloride (DADMAC), (3-methacrylamidopropyl)-trimethylammonium chloride (MAPTAC), dimethylaminopropylacrylat methochlorid, dimethylaminopropylmethacrylat methochlorid,. Monomer A is preferably DADMAC.

Monomer B is a linear or branched alkyl(meth)acrylate, preferably a C10-C30 alkyl(meth)acrylate, even more preferably a C12-C20 alkyl(meth)acrylate. Suitable monomers B include linear and branched alkyl esters of (meth)acrylic acid, such as octyl acrylate, dodecyl acrylate, lauryl acrylate, cetyl acrylate, octadecyl acrylate, isodecyl acrylate, 2-ethylhexyl acrylate. Monomer B is preferably lauryl acrylate (LA).

Monomer C is a C3-C8 monoethylenically unsaturated mono- or dicarboxylic acid as well as the anhydrides and salts thereof. Suitable examples of monomer C include acrylic acid, methacrylic acid, crotonic acid, maleic acid, maleic anhydride, fumaric acid, itaconic acid and metal salts thereof. Monomer C is preferably acrylic acid (AA).

Preferably the polymer Px is the product of the polymerization of
A) diallyl dimethyl ammonium chloride,
B) one or more linear or branched alkyl(meth)acrylates,
C) from 0 to 30 weight % of acrylic acid.

With regard to the amounts in which the respective monomers are present in the polymer Px, there are preferred ranges. Thus the polymer Px is preferably the product of the polymerization of
A) from 60 to 95 weight % of monomer A,
B) from 5 to 45 weight % of monomer B
C) from 0 to 30 weight % of monomer C.

Even more preferred is a polymer Px which is the product of the polymerization of:
A) from 70 to 90 weight % of monomer A,
B) from 10 to 35 weight % of monomer B
C) from 5 to 20 weight % of monomer C.

Another preferred embodiment is a polymer Px which is the product of the polymerization of:
A) from 70 to 90 weight % of monomer A,
B) from 10 to 35 weight % of monomer B
C) 0 weight % of monomer C.

An emulsion, wherein the surfactant(s) Sx is/are selected from the group consisting of:
c1) nonionic surfactants,
c2) anionic surfactants and
c3) cationic surfactants is preferred.

Surfactants normally consist of a hydrophobic and a hydrophilic part. Thereby the hydrophobic part normally has a chain length of 4 to 20 C-atoms, preferably 6 to 19 C-atoms and particularly preferred 8 to 18 C-atoms. The functional unit of the hydrophobic group is generally an OH-group, whereby the alcohol can be linear or branched. The hydrophilic part generally consists substantially of alkoxylated units (e.g. ethylene oxide (EO), propylene oxide (PO) and/or butylene oxide (BO), whereby generally 2 to 30, preferably 5 to 20 of these alkoxylated units are annealed, and/or charged units such as sulfate, sulfonate, phosphate, carbonic acids, ammonium and ammonium oxide.

Examples of anionic surfactants are: carboxylates, sulfonates, sulfo fatty acid methyl-esters, sulfates, phosphates. Examples for cationic surfactants are: quartery ammonium compounds. Examples for betaine-surfactants are: alkyl betaines. Examples for non-ionic compounds are: alcohol alkoxylates.

A “carboxylate” is a compound, which comprises at least one carboxylate-group in the molecule. Examples of carboxylates, which can be used according to the present invention, are

soaps—e.g. stearates, oleates, cocoates of alkali metals or of ammonium,

ethercarboxylates—e.g. Akypo® RO 20, Akypo® RO 50, Akypo® RO 90.

A “sulfonate” is a compound, which comprises at least one sulfonate-group in the molecule. Examples of sulfonates, which can be used according to the invention, are alkyl benzene sulfonates—e.g. Lutensit® A-LBS, Lutensit® A-LBN, Lutensit® A-LBA, Marlon® AS3, Maranil® DBS,

alkyl sulfonates—e.g. Alscoap OS-14P, BIO-TERGEO AS-40, BIO-TERGEO AS-40 CG, BIO-TERGEO AS-90 Beads, Calimulse® AOS-20, Calimulse® AOS-40, Calsoft® AOS-40, Colonial® AOS-40, Elfan® OS 46, Ifrapon® AOS 38, Ifrapon® AOS 38 P, Jeenate® AOS-40, Nikkol® OS-14, Norfox® ALPHA XL, POLYSTEP® A-18, Rhodacal® A-246L, Rhodacal® LSS-40/A,

sulfonated oils such as Turkish red oil,

olefine sulfonates,

aromatic sulfonates—e.g. Nekal® BX, Dowfax® 2A1.

A “sulfo fatty acid methylester” is a compound, having the following general formula (I):

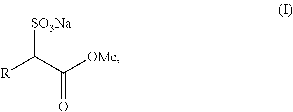

wherein R has 10 to 20 C-atoms; preferably 12 to 18 and particularly preferred 14 to 16 C-atoms.

A “sulfate” is a compound, which comprises at least one SO4-group in the molecule.

Examples of sulfates, which can be used according to the present invention, are fatty acid alcohol sulfates such as coco fatty alcohol sulfate (CAS 97375-27-4)—e.g. EMAL® 10G, Dispersogen® SI, Elfan® 280, Mackol® 100N,

other alcohol sulfates—e.g. Emal® 71, Lanette® E,

coco fatty alcohol ethersulfates—e.g. Emal® 20C, Latemul® E150, Sulfochem® ES-7, Texapon® ASV-70 Spec., Agnique SLES-229-F, Octosol 828, POLYSTEP® B-23, Unipol® 125-E, 130-E, Unipol® ES-40,

other alcohol ethersulfates—e.g. Avanel® S-150, Avanel® S 150 CG, Avanel® S 150 CG N, Witcolate® D51-51, Witcolate® D51-53.

A “phosphate” is a compound, which comprises at least one PO4-group. Examples of phosphates, which can be used according to the present invention, are

alkyl ether phosphates—e.g. Maphos® 37P, Maphos® 54P, Maphos® 37T, Maphos® 210T and Maphos® 210P,

phosphates such as Lutensit A-EP,

alkyl phosphates.

When producing the chemical composition of the present invention the anionic surfactants are preferably added as salts. Acceptable salts are e.g. alkali metal salts, such as sodium-, potassium- and lithium salts, and ammonium salts, such as hydroxyl ethylammonium-, di(hydroxy-ethyl)ammonium- and tri(hydroxyethyl)ammonium salts.

One group of the cationic surfactants are the quarternary ammonium compounds.

A “quarternary ammonium compound” is a compound, which comprises at least one

R4N+-group per molecule. Examples of counter ions, which are useful in the quarternary ammonium compounds, are

halogens, methosulfates, sulfates and carbonates of coco fat-, sebaceous fat- or cetyl/oleyltrimethylammonium.

Particularly suitable cationic surfactants are:
N,N-dimethyl-N-(hydroxy-C7-C25-alkyl)ammonium salts;
mono- and di-(C7-C25-alkyl)dimethylammonium compounds, which were quarternised with alkylating agents
esterquats, especially mono-, di- and trialkanolamines, quarternary esterified by C8-C22-carbonic acids;
imidazolinquats, especially 1-alkylimidazoliniumsalts of formula II or III

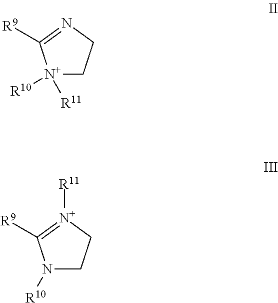

wherein the variables have the following meaning:
R9 C1-C25-alkyl or C2-C25-alkenyl;
R10 C1-C4-alkyl or hydroxy-C1-C4-alkyl;
R11 C1-C4-alkyl, hydroxy-C1-C4-alkyl or a rest R1-(CO)—X—(CH2)m- (X:—O— or —NH—; m: 2 or 3),
whereby at least one rest R9 is C7-C22-alkyl.

A “betain-surfactant” is a compound, which comprises under conditions of use—i.e. in the case of textile washing under normal pressure and at temperatures of from room temperature to 95° C.—at least one positive charge and at least one negative charge.

An “alkylbetain” is a betain-surfactant, which comprises at least one alkyl-unit per molecule. Examples of betain-surfactants, which can be used according to the invention, are

Cocamidopropylbetain—e.g. MAFO® CAB, Amonyl® 380 BA, AMPHOSOL® CA, AMPHOSOL® CG, AMPHOSOL® CR, AMPHOSOL® HCG; AMPHOSOL® HCG-50, Chembetaine® C, Chembetaine® CGF, Chembetaine® CL, Dehyton® PK, Dehyton® PK 45, Emery® 6744, Empigen® BS/F, Empigen® BS/FA, Empigen® BS/P, Genagen® CAB, Lonzaine® C, Lonzaine® CO, Mirataine® BET-C-30, Mirataine® CB, Monateric® CAB, Naxaine® C, Naxaine® CO, Norfox® CAPB, Norfox® Coco Betaine, Ralufon® 414, TEGO®-Betain CKD, TEGO® Betain EKE 1, TEGO®-Betain F, TEGO®-Betain F 50 and aminoxides such as alkyl dimethyl amineoxide, i.e. compounds of general formula (IV)

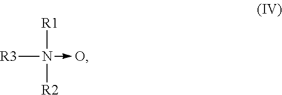

whereby R1, R2 and R3 are chosen independently from each other of an aliphatic, cyclic or tertiary alkyl- or amido alkyl-moiety, e.g. Mazox® LDA, Genaminox®, Aromox® 14 DW 970.

Non-ionic surfactants are interfacially active substances having a head group, which is an uncharged, polar, hydrophilic group, not carrying a ionic charge at neutral pH, and which head group makes the non-ionic surfactant water soluble. Such a surfactant adsorbs at interfaces and aggregates to micelles above the critical micelle concentration (cmc). According to the type of the hydrophilic head group it can be distinguished between (oligo)oxyalkylene-groups, especially (oligo)oxyethylene-groups, (polyethyleneglycol-groups), including fatty alcohol polyglycole ether (fatty alcohol alkoxylates), alkylphenol polyglycolether and fatty acid ethoxylates, alkoxylated triglycerides and mixed ethers (polyethylene glycolether alcoxylated on both sides); and carbohydrate-groups, including e.g. alkyl polyglucosides and fatty acid-N-methyl-glucamides.

Alcohol alkoxylates, are based on a hydrophobic part having a chain length of 4 to 20 C-atoms, preferably 6 to 19 C-atoms and particularly preferred 8 to 18 C-atoms, whereby the alcohol can be linear or branched, and a hydrophilic part, which can be alkoxylated units, e.g. ethylene oxide (EO), propylene oxide (PO) and/or butylene oxide (BuO), having 2 to 30 repeating units. Examples are besides others Lutensol® XP, Lutensol® XL, Lutensol® ON, Lutensol® AT, Lutensol® A, Lutensol® AO, Lutensol® TO.

Alcoholphenolalkoxylates are compounds according to general formula (V),

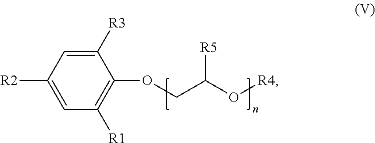

which can be produced by addition of alkylene oxide, preferably ethylene oxide onto alkyle phenoles. Preferably R4=H. It is also preferred, if R5=H, —since than it is EO; in the same way it is preferred if R5=CH3, since than it is PO, or, if R5=CH2CH3 since than it is BuO. A compound is especially preferred, in which octyl-[(R1=R3=H, R2=1,1,3,3-tetramethylbutyl (diisobutylene)], nonyl-[(R1=R3=H, R2=1,3,5-trimethylhexyl(tripropylene)], dodecyl-, dinonyl- or tributylphenolpolyglycolether (e.g. EO, PO, BuO), R—C6H4-O-(EO/PO/BuO)n with R=C8 to C12 and n=5 to 10, are present. Non-limiting examples of such compounds are: Norfox® OP-102, Surfonic® OP-120, T-Det® 0-12.

Fatty acid ethoxylates are fatty acid esters, which have been treated with different amounts of ethylene oxide (EO).

Triglycerides are esters of the glycerols (glycerides), in which all three hydroxy-groups have been esterified using fatty acids. These can be modified by alkylene oxides.

Fatty acid alkanol amides are compounds of general formula (VI)

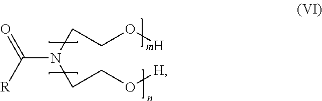

which comprise at least one amide-group having one alkyl moiety R and one or two alkoxyl-moiety(ies), whereby R comprises 11 to 17 C-atoms and 1≦m+n≦5.

Alkylpolyglycosides are mixtures of alkylmonoglucosides (alkyl-α-d- and -β-d-gluco-pyranoside plus small amounts of -glucofuranoside), alkyldiglucosides (-isomaltosides, -maltosides and others) and alkyloligoglucosides (-maltotriosides, -tetraosides and others). Alkylpolyglycosides are among other routes accessible by acid catalysed reaction (Fischer-reaction) from glucose (or starch) or from n-butylglucosides with fatty alcohols. Alkylpolyglycosides fit general formula (VII)

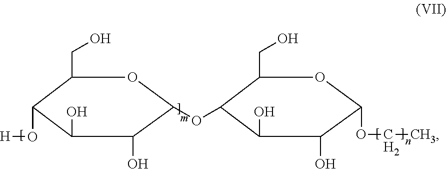

with

m=0 to 3 and

n=4 to 20.

One example is Lutensol GD70.

In the group of non-ionic N-alkylated, preferably N-methylated, fatty acid amides of general formula (VIII)

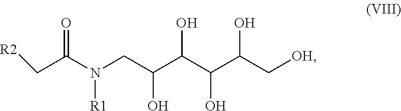

R1 is a n-C12-alkyl-moiety, R2 an alkyl-moiety having 1 to 8 C-atoms. R2 preferably is methyl.

An emulsion, wherein the additive(s) Ax is/are selected from the group consisting of: disinfectant, dye, acid, base, complexing agent, biocide, hydrotope, thickener, builder, cobuilder, enzyme, bleaching agent, bleach activator, bleaching catalyst, corrosion inhibitor, dye protection additive, dye transfer inhibitor, anti-greying agent, soil-release-polymer, fiber protection agent, silicon, bactericide, preserving agent, organic solvent, solubility adjustor, solubility enhancer, perfume gel formers, dyes, pigments, photoprotective agents, consistency regulators, antioxidants, bleaches, care agents, tints, tanning agents, humectants, refatting agents, collagen, protein hydrolysates, lipids, emollients, softeners, antifoams, antistats, resins, solvents, solubility promoters, neutralizing agents, stabilizers, sterilizing agents, propellants, drying agents, opacifiers is preferred.

Disinfectants can be: oxidation agents, halogens such as chlorine and iodine and substances, which release the same, alcohols such as ethanol, 1-propanol and 2-propanol, aldehydes, phenoles, ethylene oxide, chlorohexidine and mecetronium-metilsulfate.

The advantage of using disinfectants is that pathogenic germs can hardly grow. Pathogenic germs can be: bacteria, spores, fungi and viruses.

Dyes can be besides others: Acid Blue 9, Acid Yellow 3, Acid Yellow 23, Acid Yellow 73, Pigment Yellow 101, Acid Green 1, Acid Green 25.

Acids are compounds that can advantageously be used to solve or to avoid scaling. Non-limiting examples of acids are formic acid, acetic acid, citric acid, hydrochloric acid, sulfuric acid and sulfonic acid.

Bases are compounds, which are useful for adjusting a preferable pH-range for complexing agents. Examples of bases, which can be used according to the present invention, are: NaOH, KOH and amine ethanol.

As inorganic builder the following are especially useful:
crystalline and amorphous alumino silicates having ion exchanging properties, such as zeolites: different types of zeolites are useful, especially those of type A, X, B, P, MAP and HS in their Na-modification or in modifications in which Na is partially substituted by other cat ions such as Li, K, Ca, Mg or ammonium;
crystalline silicates, such as disilicates and layered-silicates, e.g. δ- and β-Na2Si2O5. The silicates can be used as alkali metal-, earth alkali metal- or ammonium salts, the Na-, Li- and Mg-silicates are preferred;
amorphous silicates, such as sodium metasilicate and amorphous disilicate;
carbonates and hydrogencarbonates: These can be used as alkali metal-, earth alkali metal- or ammonium salts. Na-, Li- and Mg-carbonates and -hydrogen carbonate, especially sodium carbonate and/or sodium hydrogen carbonate are preferred;
polyphosphates, such as pentanatriumtriphosphate.

Useful as oligomeric and polymeric cobuilders are:

Oligomeric and polymeric carbonic acids, such as homopolymers of acrylic acid and aspartic acid, oligomaleic acid, copolymers of maleic acid and acrylic acid, methacrylic acid or C2-C22-olefines, e.g. isobutene or long chain a-olefines, vinyl-C1-C8-alkylether, vinylacetate, vinylpropionate, (meth)acryl acid ester of C1-C8-alcohols and styrene. Preferred are the homopolymers of acrylic acid and the copolymers of acrylic acid with maleic acid. The oligomeric and polymeric carbonic acids preferably are used as acids or as sodium salts.

Chelating agents are compounds, which can bind cat ions. They can be used to reduce water hardness and to precipitate heavy metals. Examples of complexing agents are: NTA, EDTA, MGDA, DTPA, DTPMP, IDS, HEDP, β-ADA, GLDA, citric acid, oxodisuccinic acid and butanetetracarbonic acid. The advantage of the use of these compounds lies in the fact that many compounds, which serve as cleaning agents, are more active in soft water. In addition to that scaling can be reduced or even be avoided. By using such compounds there is no need to dry a cleaned surface. This is an advantage in the work flow.

Useful anti greying agents are e.g. carboxymethylcellulose and graft polymers of vinyl acetate on polyethylene glycol.

Useful bleaching agents are e.g. adducts of hydrogenperoxide as inorganic salts, such as sodium perborate-monohydrate, sodium perborate-tetrahydrate and sodium carbonate-perhydrate, and percarbonic acids, such as phthalimidopercapronic acid.

As bleach activators compounds such as N,N,N′,N′-tetraacetylethylendiamine (TAED), sodium-p-nonanoyloxybenzenesulfonate and N-methylmorpholiniumacetonitrilemethyl-sulfate are useful.

Useful enzymes are e.g. proteases, lipases, amylases, cellulases, mannanases, oxidases and peroxidases.

Useful as dye transfer inhibitors are e.g. homo-, co- and graft-polymers of 1-vinylpyrrolidone, 1-vinylimidazol or 4-vinylpyridine-N-oxide. Also homo- and copolymers of 4-vinylpyridin, which have been treated with chloro acetic acid are useful dye transfer inhibitors.

Biocides are compounds, which kill bacteria. An example of a biocide is glutaric aldehyde. The advantage of the use of biocides is that the spreading of pathogenic germs is counteracted.

Hydrotropes are compounds which enhance the solubility of the surfactant/the surfactants in the chemical composition. An example is: Cumolsulfonate.

Thickeners are compounds, which enhance the viscosity of the chemical composition. Non-limiting examples of thickeners are: polyacrylates and hydrophobically modified polyacrylates. The advantage of the use of thickeners is, that liquids having a higher viscosity have a longer residence time on the surface to be treated in the cases this surface is inclined or even vertical. This leads to an enhanced time of interaction.

An emulsion, which has a content of organic solvent below 50 mg/kg of emulsion is particularly preferred.

An emulsion according as described above, which is stable for more than 2 days according to the phase-stability-test forms a preferred embodiment of the present invention.

Phase-Stability-Test:

The stability of the emulsion is tested by visual inspection via the phase-stability-test. After preparation, the emulsion is stored in a closed graduated cylinder (Hirschmann Duran 100 ml volume, NS24/29) at room temperature without agitation. After 1 h, 4 h, 24 h and 48 h, the emulsion is inspected for phase separation.
The emulsion is defined stable when no visually observable phase separation occurs after 48 h.
The emulsion is defined as re-emulsifiable when phase separation occurs after 48 h, but the emulsion is immediately reformed upon slight shaking or stirring with low shear, for example with a magnetic stirrer bar, and the reformed emulsion is stable again for at least four hours.
The emulsion is defined unstable, when phase separation occurs shortly after preparation and the emulsion can not be reformed by slight shaking or stirring with low shear, for example with a magnetic stir bar.

A process for making an emulsion as described above, comprising the steps of: combining polyolefine(s), polymer(s) Px, water and optionally oil(s) Ox, surfactant(s) Sx and additives Ax and homogenizing said components in a mechanical mixer without the use of a solvent forms another aspect of the present invention.

Regarding the details of the process different versions are possible.

The emulsions can be prepared by processes known in the literature, for example in Heusch, R., “Ullmann's Encyclopedia of Industrial Chemistry”, Chapter “Emulsions”, 1-47, Wiley-VCH, 2000 (DOI: 10.1002/14356007.a09_{—}297) or in Kostansek, E., “Kirk-Othmer Encyclopedia of Chemical Technology”, Vol. 10, 113-133, Chapter “Emulsions”, John Wiley & Sons 2003 (DOI: 10.1002/0471238961.-0513211206180902.a01.pub2).

Suitable emulsifying machines are for example high-speed stirrers, agitation or impact machines, emulsifier centrifuges, colloid mills, metering pumps (atomizers), vibrators, ultrasonic generators and homogenizers.

In one preferred embodiment of the invention, the preparation of the emulsion is achieved via a solvent-free route (a solvent being a substance with a boiling point below 150° C. that can dissolve the oil(s) a), for example o-xylene) by combination of the components, comprising oil(s), polymer(s) Px, water, optionally surfactant, and optionally further additives such as defoamers etc., and homogenization with a suitable device, like for example a high-shear mixer or for example a high-pressure homogenizer, optionally at elevated temperatures.

The step of combining the components can vary: in one preferred embodiment, polymer(s) Px is dissolved in the oil(s), optionally additional components, and then combined with the water phase, comprising water, optionally surfactant and additional components.

In another preferred embodiment, polymer(s) Px is dissolved in the water phase, comprising water, optionally surfactant and/or additional components, and then combined with the oil phase, comprising oil(s) and optionally additional components.

In another preferred embodiment of the invention, the preparation of the emulsion is achieved via a solvent route. The components of the emulsion, comprising oil(s) a) and polymer(s) Px, are dissolved in a solvent, for example o-xylene, in a stirred reactor, optionally at elevated temperatures. After complete dissolution, water is added to the solution and the mixture is distilled, optionally under addition of water steam, at elevated temperature (above 80° C.) until the solvent is removed.

The use of an emulsion as described above in chemical technical applications, car wash, cosmetics, plant protection, preparation and treatment of paper, textiles and leather, adhesives, dye and pigment formulations, coatings, pharmaceutical applications, construction, wood treatment forms another aspect of the present invention.

The present invention will be disclosed further by the following non-limiting examples:

### EXAMPLES

“Low concentrated emulsions” shall mean emulsions where the water content lies above 40 weight %, preferably in the range of from 45 weight % to 65 weight %, based on the total weight of the emulsion.

“Highly concentrated emulsions” shall mean emulsions where the water content lies below or is equal to 40 weight %, preferably in the range from 20 weight % to 35 weight %, based on the total weight of the emulsion.

The cleaning and/or treatment compositions of the present invention can be formulated into any suitable form and prepared by any process chosen by the formulator, non-limiting examples of which are described in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

Analytical Methods:

K-Value

The K value of the polymers of the invention was determined in accordance with

Fikentscher (see H. Fikentscher, Cellulosechemie 13 (1932), 58-64 and 71-74) by measuring the viscosity of 0.1% strength by weight solutions of the polymers in 3% strength by weight NaCI solution.

Solids Content

The solid content was determined by drying the aqueous solution of the polymer in an oven at 100° C., for 2 h, at reduced pressure (100 mbar).

### Examples P1 to P12

### Synthesis of the Polymeric Cationic Emulsifier Px

### Example P1

In a 2 L stirred vessel, water (38 g) and isopropanol (230 g) were charged and heated to 80° C. under a flow of nitrogen. A solution of laurylacrylate (71 g) in isopropanol (230 g) as well as a 65% aqueous solution of diallyldimethylammoniumchloride (366 g) and acrylic acid (21 g) are added each in separate feeds over 4 h at 80° C. At the same time, a solution of 2,2′-azobis(2-methylpropionamidine) dihydrochloride (3.3 g, supplied by Wako Specialty Chemicals) in water (44 g) is added over 4.25 h. The polymerization mixture is kept at this temperature for an additional 1 h. The isopropanol was removed by distillation and water (506 g) was added to yield a 36% solution of terpolymer P1.

### Example P3

In a 2 L stirred vessel, water (31 g) and isopropanol (230 g) were charged and heated to 80° C. under a flow of nitrogen. A solution of laurylacrylate (75 g) in isopropanol (230 g), and a 65% aqueous solution of diallydimethylammoniumchloride (388 g) were added in separate feeds over 4 h at 80° C. At the same time, a solution of sodiumperoxodisulfate (3.3 g) in water (43 g) is added over 4.25 h. The polymerization mixture is kept at this temperature for an additional 1 h. The isopropanol was removed by distillation and water (498 g) was added to yield a 38% solution of the copolymer P3.

### Example P11

In a 2 L stirred vessel, water (33 g) and isopropanol (195 g) were charged and heated to 80° C. under a flow of nitrogen. A solution of laurylacrylate (75 g) in isopropanol (194 g) and 65% aqueous solution of diallydimethylammoniumchloride (310 g) were added in separate feeds over 4 h at 80° C. At the same time, a solution of 2,2′-azobis(2-methylpropionamidine)dihydrochloride (2.8 g, supplied by Wako Specialty Chemicals) in water (37 g) are added over 4.25 h. The polymerization mixture is kept at this temperature for an additional 1 h. The isopropanol was removed by distillation and water (390 g) was added. This yielded a 37% solution of copolymer P11.

### Further Polymerization Examples

Polymers P6-P10 as well as Comparative Polymers CP1 and CP2 were prepared in a similar way as described in Example P1, taking the monomers and the respective amounts given in Table 1.

Polymers P2, P4, P5 and P11 were prepared in a similar way as described in Example P11, taking the monomers and the respective amounts given in Table 1.

TABLE 1

| | | | | | | | | | Precharge | Precharge | Solids | |
|---|---|---|---|---|---|---|---|---|---|---|---|---|
| | DADMAC | LA | AA | DADMAC | LA | AA | Isopropanol | Init. | Water | Isopropanol | Content | |
| Ex.: | [wt.-%] | [wt.-%] | [wt.-%] | [g] | [g] | [g] | [g] | [g] | [g] | [g] | [wt.-%] | K-Value |
| P1 | 71.40 | 14.30 | 14.30 | 366.2 | 70.9 | 21.3 | 220 | 3.30 | 43.9 | 223.0 | 36.1 | 16 |
| P2 | 90.00 | 10.00 | 0.00 | 462.1 | 49.6 | 0.0 | 152 | 3.50 | 18.8 | 325.9 | 40.2 | 15 |
| P3 | 83.30 | 16.60 | 0.00 | 387.3 | 75.0 | 0.0 | 230 | 3.27 | 31.2 | 229.9 | 35.0 | 21 |
| P4 | 82.50 | 17.50 | 0.00 | 444.4 | 91.1 | 0.0 | 388 | 3.80 | 36.2 | 141.5 | 35.0 | 14 |
| P5 | 75.00 | 25.00 | 0.00 | 411.4 | 132.6 | 0.0 | 432 | 4.00 | 57.8 | 125.6 | 36.8 | 11 |
| P6 | 70.00 | 25.00 | 5.00 | 393.7 | 135.9 | 8.2 | 442 | 4.00 | 64.0 | 114.6 | 38.5 | 13 |
| P7 | 76.25 | 17.50 | 6.25 | 436.2 | 96.8 | 10.4 | 315 | 3.91 | 64.8 | 226.8 | 38.2 | 12 |
| P8 | 80.00 | 10.00 | 10.00 | 483.2 | 58.4 | 17.5 | 190 | 3.90 | 27.11 | 352.0 | 37.5 | 14 |
| P9 | 70.00 | 17.50 | 12.50 | 434.5 | 105.2 | 22.5 | 343 | 4.10 | 77.6 | 226.5 | 38.7 | 12 |
| P10 | 70.00 | 10.00 | 20.00 | 417.9 | 57.7 | 34.6 | 188 | 3.65 | 37.27 | 318.9 | 40.1 | n.d. |
| P11 | 80.00 | 20.00 | 0.00 | 310.4 | 75.1 | 0.0 | 195 | 2.77 | 32.9 | 194.7 | 37.0 | 16 |
| P12 | 66.67 | 33.33 | 0.00 | 288.1 | 139.5 | 0.0 | 230 | 3.27 | 66.1 | 229.8 | 36.6 | 12 |
| CP1 | 73.30 | 0.00 | 26.70 | 136.65 | 0.0 | 32.4 | 0.0 | 0.6 | 352.9 | 0.0 | 22.8 | 12 |
| CP2 | 54.70 | 0.00 | 45.30 | 261.15 | 0.0 | 140.5 | 0.0 | 0.05 | 337.43 | 0.0 | 41.6 | 67.8 |

### Examples LC1 to LC12

### Preparation of Low Concentrated Emulsions

### Example LC1

Polyisobutene (FIB) (molecular weight 1000 g/mol) (17.5 parts per weight) and paraffin oil (17.5 parts per weight) were mixed and the mixture heated to 80° C.

Polymer P1 (1.75 parts per weight, calculated as active content) and nonionic surfactant C10-Guerbetalcohol alkoxylate (HLB 12.5, 8.8 parts per weight) were mixed with de-ionized water (54.4 parts per weight) and heated to 80° C. as well. The FIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous emulsion that is stable against phase-separation for >1 week is formed.

### Example LC2-LC12

The following examples were prepared in a similar way as described in Example LC1, using the same quantities of the respective polymers P2-P12. The stability results are given in Table 2. Emulsion stability is assessed by visual inspection after 2 h, 3 days and 6 days, and an average is calculated. All emulsions were homogeneous and did not show phase separation. Some emulsions showed creaming after 3 d or 6 d. The degree of creaming is assessed and graded by visual inspection, with grade 1 being a perfectly homogeneous emulsion showing not signs of creaming, and grade 6 being an emulsion that is completely creamed. Nevertheless, all emulsions were stable against phase separation and a homogeneous emulsion could easily be reformed by shaking or stirring with a low shear magnetic stirrer.

TABLE 1

| Example | Polymer: | 2 h | 3 d | 6 d | Average |
|---|---|---|---|---|---|
| LC1 | P1 | 1.0 | 1.0 | 1.0 | 1.0 |
| LC2 | P2 | 1.0 | 1.0 | 3.0 | 1.7 |
| LC3 | P3 | 1.0 | 1.0 | 1.0 | 1.0 |
| LC4 | P4 | 3.0 | 3.0 | 3.0 | 3.0 |
| LC5 | P5 | 6.0 | 3.0 | 6.0 | 5.0 |
| LC6 | P6 | 6.0 | 6.0 | 6.0 | 6.0 |
| LC7 | P7 | 1.0 | 1.0 | 3.0 | 1.7 |
| LC8 | P8 | 1.0 | 1.0 | 3.0 | 1.7 |
| LC9 | P9 | 1.0 | 3.0 | 3.0 | 2.3 |
| LC10 | P10 | 1.0 | 1.0 | 3.0 | 1.7 |

### Examples HC1 to HC12

### Preparation of Highly Concentrated Emulsions

### Example NC1

Polyisobutene (PIB) (molecular weight 1000 g/mol) (10.0 g, 41.6 parts per weight) was heated to 80° C.

Polymer P1 (4.25 g calculated as solid polymer, 17.3 parts per weight) and nonionic surfactant C10-Guerbetalcohol alkoxylate (HHB 12.5) (2.55 g, 10.4 parts per weight) were mixed and heated to 80° C. as well. The residual water originates from the water content of the raw materials.

The PIB was placed in a heated beaker and fitted with a high shear mixer (Polytron PT 10-35 GT) and the speed was set to 8000 to 10000 rpm. At 80° C. the mixture of polymer and non-ionic surfactant was added and treated at this shear rate for 120 sec without further heating. A homogeneous, highly concentrated emulsion that is stable against phase-separation for >2 week is formed.

### Examples HC2-HC12

The following examples were prepared in a similar way as described in Example HC1, taking the polymers and the respective amounts given in Table 3. All emulsions HC1-HC12 can be diluted with water by simple low-shear stirring with a magnetic stirrer bar. Emulsion stability is assessed by visual inspection after 4 h and 14 days. Emulsions are graded “homogeneous” (H in Table 3) when no visually observable creaming/sedimentation and no coalescence and phase separation can be observed; they are graded “creaming” when creaming (CR) was observed but a homogeneous emulsion could be reformed by low-shear stirring. Emulsions were graded “phase separation” (PS) when an oily phase was reformed and the emulsion could not easily be simple low-shear stirring.

TABLE 2

| | | | Polymer (calculated | Nonionic | | | |
|---|---|---|---|---|---|---|---|
| | | Polyisobutene | as active) | Surfactant | Residual Water | | Emulsion Stability |
| Example | Polymer: | [wt.-%] | [wt.-%] | [wt.-%] | [wt.-%] | Emulsion Stability (4 h) | (14 days) |
| HC1 | P1 | 41.6 | 17.3 | 10.4 | 30.7 | H | H |
| HC2 | P2 | 43.7 | 18.2 | 10.9 | 27.1 | H | CR |
| HC3 | P3 | 41.0 | 17.1 | 10.2 | 31.7 | H | CR |
| HC4 | P4 | 44.2 | 18.4 | 11.0 | 26.4 | H | CR |
| HC5 | P5 | 42.0 | 17.5 | 10.5 | 30.0 | H | H |
| HC6 | P6 | 42.9 | 17.9 | 10.7 | 28.5 | H | PS |
| HC7 | P7 | 42.7 | 17.8 | 10.7 | 28.8 | H | PS |
| HC8 | P8 | 42.4 | 17.6 | 10.6 | 29.4 | H | CR |
| HC9 | P9 | 43.0 | 17.9 | 10.7 | 28.4 | H | PS |
| HC10 | P10 | 43.7 | 18.2 | 10.9 | 27.2 | H | CR |
| HC11 | P11 | 41.6 | 17.7 | 10.6 | 30.1 | H | H |
| HC12 | P12 | 41.4 | 17.6 | 10.6 | 30.5 | H | PS |

H = Homogeneous,
CR = Creaming,
PS = Phase separation.

### COMPARATIVE EXAMPLES

### Comparative Example HC11

Polyisobutene (PIB) (molecular weight 1000 g/mol) (17.5 parts per weight) and paraffin oil (17.5 parts per weight) were mixed and the mixture heated to 80° C.

The copolymer of DADMAC and acrylic acid CP1 (1.75 parts per weight, calculated as active content) and nonionic surfactant C10-Guerbetalcohol alkoxylate (HLB 12.5, 8.8 parts per weight) were mixed with de-ionized water (54.4 parts per weight) and heated to 80° C. as well.

The FIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. The resulting mixture showed creaming immediately after emulsification and was separated into a clear water phase below and a white highly viscous phase on top. After stirring, creaming reappeared immediately.

### Comparative Example HC12

Polyisobutene (FIB) (molecular weight 1000 g/mol) (17.5 parts per weight) and paraffin oil (17.5 parts per weight) were mixed and the mixture heated to 80° C.

The copolymer of DADMAC and acrylic acid CP2 (1.75 parts per weight, calculated as active content) and nonionic surfactant C10-Guerbetalcohol alkoxylate (HLB 12.5, 8.8 parts per weight) were mixed with de-ionized water (54.4 parts per weight) and heated to 80° C. as well.

The FIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. The resulting mixture showed creaming after approx. 4 hours and was separated into a clear water phase below and a white highly viscous phase on top. After stirring, creaming reappeared immediately.

### Comparative Example HC13

Polyisobutene (FIB) (molecular weight 1000 g/mol) (17.5 parts per weight) and paraffin oil (17.5 parts per weight) were mixed and the mixture heated to 80° C. The DADMAC homopolymer CP3 (commercial Poly-DADMAC sample, (as supplied for example by Sigma-Aldrich under order numbers 522376 or 409014, CAS-# 26062-79-3) (1.75 parts per weight, calculated as active content) and nonionic surfactant C10-Guerbetalcohol alkoxylate (HLB 12.5, 8.8 parts per weight) were mixed with de-ionized water (54.4 parts per weight) and heated to 80° C. as well.

The PIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. The resulting mixture showed creaming immediately after emulsification and was separated into a clear water phase below and a white highly viscous phase on top. After stirring, creaming reappeared immediately.

Further Emulsification Experiments:

Experiment A:

Paraffin (35.0 parts per weight) was heated to 80° C. Polymer P1 (5 parts per weight, calculated as active content) and nonionic surfactant C10-Guerbetalcohol alkoxylate (HLB 12.5, 8.8 parts per weight) were mixed with de-ionized water (51.2 parts per weight) and heated to 80° C. as well.

The Paraffin was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous paraffin emulsion that is stable against phase-separation for >2 week is formed.

Experiment B:

Corn oil (35.0 parts per weight) was heated to 80° C. Polymer P1 (5 parts per weight, calculated as active content) and nonionic surfactant C10-Guerbetalcohol alkoxylate (HLB 12.5, 8.8 parts per weight) were mixed with de-ionized water (51.2 parts per weight) and heated to 80° C. as well.

The corn oil was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous paraffin emulsion that is stable against phase-separation for >2 week is formed.

Experiment C:

Soy bean oil (35.0 parts per weight) was heated to 80° C. Polymer P1 (5 parts per weight, calculated as active content) and nonionic surfactant C10-Guerbetalcohol alkoxylate (HLB 12.5, 8.8 parts per weight) were mixed with de-ionized water (51.2 parts per weight) and heated to 80° C. as well.

The soy bean oil was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous paraffin emulsion that is stable against phase-separation for >2 week is formed.

The following example formulations are made containing the emulsions of the present invention:

Preparation of a Standard Liquid Detergent Formulation (A):

Liquid detergent fabric care compositions of Example A are made by mixing together the ingredients listed in the proportions shown;

| Ingredient (wt %) | A |
|---|---|
| C12-C15 alkyl polyethoxylate (1.8) sulfate 1 | 20.1 |
| C12 alkyl trimethyl ammonium chloride 4 | 2.0 |
| C12-C14 alcohol 9 ethoxylate 3 | 0.8 |
| Monoethanolamine | 2.5 |
| Na cumenesulfonate | 1.8 |
| C12-C18 Fatty Acid 5 | 1.0 |
| Citric acid 6 | 3.4 |
| Protease 7 (52 g/L) | 0.35 |
| Fluorescent Whitening Agent 8 | 0.08 |
| Diethylenetriamine pentaacetic acid 6 | 0.5 |
| Ethoxylated polyamine 9 | 0.6 |
| PIB emulsion from examples P1-P12, CP1-CP2, | 0.01-20.0 |
| LC1-LC12, and/or HC1-HC12 | |
| Water, perfumes, dyes, buffers, solvents and | to 100% |
| other optional components | pH 8.0-8.2 |

1 Available from Shell Chemicals, Houston, TX.
2 Available from Sasol Chemicals, Johannesburg, South Africa
4 Available from Evonik Corporation, Hopewell, VA.
5 Available from The Procter & Gamble Company, Cincinnati, OH.
6 Available from Sigma Aldrich chemicals, Milwaukee, WI
7 Available from Genencor International, South San Francisco, CA.
8 Available from Ciba Specialty Chemicals, High Point, NC
9 600 g/mol molecular weight polyethylenimine core with 20 ethoxylate groups per —NH and available from BASF (Ludwigshafen, Germany)

1 Available from Shell Chemicals, Houston, Tex.

2 Available from Sasol Chemicals, Johannesburg, South Africa

4 Available from Evonik Corporation, Hopewell, Va.

5 Available from The Procter & Gamble Company, Cincinnati, Ohio.

6 Available from Sigma Aldrich chemicals, Milwaukee, Wis.

7 Available from Genencor International, South San Francisco, Calif.

8 Available from Ciba Specialty Chemicals, High Point, N.C.

9 600 g/mol molecular weight polyethylenimine core with 20 ethoxylate groups per —NH and available from BASF (Ludwigshafen, Germany)

Preparation of a Standard Liquid Fabric Enhancer Formulation (B):

Rinse-Added fabric care compositions are prepared by mixing together ingredients shown below:

| Ingredient | B |
|---|---|
| Fabric Softener Active 1 | 11.0 |
| PIB emulsion from examples P1-P12, CP1-CP2, | 0.01-20.0 |
| LC1-LC12, and/or HC1-HC12 | |
| Lutensol XL-70 2 | 1.0 |
| Quaternized polyacrylamide 4 | 0.25 |
| Calcium chloride 3 | 0.15 |
| Ammonium chloride 3 | 0.1 |
| Alkyl siloxane polymer 6 | 1.5 |
| Perfume | 1.75 |
| Perfume microcapsule 5 | 0.69 |
| Water, suds suppressor, stabilizers, pH control | to 100% |
| agents, buffers, dyes & other optional ingredients | pH = 3.0 |

N,N-di(tallowoyloxyethyl)—N,N dimethylammonium chloride available from Evonik Corporation, Hopewell, Va.

Available from BASF (Ludwigshafen, Germany)

Available from Sigma Aldrich chemicals, Milwaukee, Wis.

Cationic polyacrylamide polymer such as a copolymer of acrylamide/[2-(acryloylamino)ethyl]tri-methylammonium chloride (quaternized dimethyl aminoethyl acrylate) available from BASF, AG, Ludwigshafen under the trade name Sedipur® 544.

Available from Appleton Paper of Appleton, Wis.

Aminofunctional silicone available from Shin-Etsu Silicones, Akron, Ohio

1.-15. (canceled)

16. Emulsion comprising
a) oil(s) in an amount of from 2 to 75 weight %,
b) polymeric cationic emulsifiers Px in an amount of from 0.05 to 40 weight %,
wherein Px is the product of the polymerization of
A) one or more cationic ethylenically unsaturated monomers (monomer A),
B) one or more linear or branched alkyl(meth)acrylates (monomer B),
C) from 0 to 30 weight % of one or more C3-C8 monoethylenically unsaturated carboxylic acids (monomer C),
c) surfactant(s) Sx in an amount of from 0 to 25 weight %,
d) additive(s) Ax in an amount of from 0 to 20 weight % and
e) water in an amount of from 10 to 97.95 weight %, based on the total weight of the emulsion.

17. Emulsion according to claim 16, wherein the components independently of each other are present in amounts of:
a) oil(s) in an amount of from 5 to 50 weight %,
b) polymeric cationic emulsifiers Px in an amount of from 0.5 to 30 weight %,
wherein Px is the product of the polymerization of
A) one or more monomers A,
B) one or more monomers B,
C) from 0 to 30 weight % of one or monomers C,
c) surfactant(s) Sx in an amount of from 0.1 to 20 weight %,
d) additive(s) Ax in an amount of from 0.1 to 15 weight % and
e) water in an amount of from 30 to 90 weight %,
based on the total weight of the emulsion.

18. Emulsion according to claim 16, wherein the components independently of each other are present in amounts of:
a) oil(s) in an amount of from 10 to 40 weight %,
b) polymeric cationic emulsifiers Px in an amount of from 0.5 to 15 weight %,
wherein Px is the product of the polymerization of
A) one or more monomers A,
B) one or more monomers B,
C) from 0 to 30 weight % of one or more monomers C,
c) surfactant(s) Sx in an amount of from 0.1 to 15 weight %,
d) additive(s) Ax in an amount of from 1 to 10 weight % and
e) water in an amount of from 40 to 85 weight %,
based on the total weight of the emulsion.

19. Emulsion according to claim 16, wherein the components independently of each other are present in amounts of:
a) oil(s) in an amount of from 15 to 30 weight %,
b) polymeric cationic emulsifiers Px in an amount of from 0.5 to 5 weight %,
wherein Px is the product of the polymerization of
A) one or more monomers A,
B) one or more monomers B,
C) from 0 to 30 weight % of one or more monomers C,
c) surfactant(s) Sx in an amount of from 0.5 to 10 weight %,
d) additive(s) Ax in an amount of from 2 to 8 weight % ad
e) water in an amount of from 50 to 80 weight %,
based on the total weight of the emulsion.

20. Emulsion according to claim 16, wherein the oil(s) is/are selected from the group consisting of:
a1) polyolefines,
a2) silicone oils,
a3) natural oil(s),
a4) mineral oils, having a boiling point at atmospheric pressure of 150° C. or higher,
a5) esters of C10- to C26-carboxylic acid with C8-C24-alcohols,
and/or mixtures thereof.

21. Emulsion according to claim 16, wherein the oil(s) is/are selected from the group consisting of: polyethylene, polypropylene, polybutylene and polyisobutene.

22. Emulsion according to claim 16, wherein the polymeric cationic emulsifier PX is the product of the polymerization of
A) from 60 to 95 weight % of monomer A,
B) from 5 to 45 weight % of monomer B
C) from 0 to 30 weight % of monomer C.

23. Emulsion according to claim 16, wherein the polymeric cationic emulsifier PX is the product of the polymerization of
A) diallyl dimethyl ammonium chloride,
B) one or more linear or branched C12-C20 alkyl(meth)acrylates,
C) from 0 to 30 weight % of acrylic acid

24. Emulsion according to claim 16, wherein the polymeric cationic emulsifier PX is the product of the polymerization of
A) diallyl dimethyl ammonium chloride,
B) lauryl acrylate,
C) from 0 to 30 weight % of acrylic acid

25. Emulsion according to claim 16, wherein the surfactant(s) Sx is/are selected from the group consisting of:
c1) nonionic surfactants,
c2) anionic surfactants and
c3) cationic surfactants.

26. Emulsion according to claim 16, which has a content of organic solvent below 50 mg/kg of emulsion.

27. Process for making an emulsion according to claim 16, comprising the steps of: combining oil(s), polymer(s) Px, water and optionally surfactant(s) Sx and additives Ax and homogenizing said components in a mechanical mixer without the use of a solvent.

28. Use of an emulsion according to claim 16 in chemical technical applications, car wash, cosmetics, plant protection, preparation and treatment of paper, textiles and leather, adhesives, dye and pigment formulations, coatings, pharmaceutical applications, construction, wood treatment.

29. A polymer Px which is the product of the polymerization of
A) diallyl dimethyl ammonium chloride,
B) lauryl acrylate

30. A polymer Px which is the product of the polymerization of
A) diallyl dimethyl ammonium chloride,
B) linear or branched C12-C20 alkyl(meth)acrylates
C) acrylic acid
